(19) United States
(12) Patent Application Publication
(10) Pub. No.: US 2011/0148206 A1
(43) Pub. Date: Jun. 23, 2011

(54) In-line uninterruptible power supply

(76) Inventor: Maurilio Hernandez, Chicago, IL (US)

(21) Appl. No.: 12/653,978

(22) Filed: Dec. 21, 2009

(51) Int. Cl. H02J 9/06

(52) U.S. Cl. 307/66

(57) ABSTRACT

An in-line uninterruptible power supply for use with an electronic device having a base unit and a power adapter is presented. In particular, the in-line UPS is positioned between the electronic device's power adapter and the base unit, and is structured to supply continuous power to the electronic device, even in the event of a temporary power failure. Moreover, the in-line UPS comprises an input signal converter, such as a DC-DC voltage converter which is structured to convert a UPS input signal to a battery input signal. The in-line UPS further comprises an output signal converter, such as a DC-DC voltage converter structured to convert a battery output signal to a UPS output signal, wherein the UPS input signal and the UPS output signal are substantially equivalent.

### BACKGROUND OF THE INVENTION

1. Field of the Invention

The present invention is generally directed to an in-line uninterruptible power supply for use with an electronic device having a base unit and a removable power adapter. In particular, the in-line uninterruptible power supply of the various embodiments of the present invention is cooperatively positioned between the removable power adapter and the base unit of the electronic device, which provides numerous advantages and benefits as discussed in greater detail hereinafter, and is structured and configured to supply continuous power to the electronic device, even in the event of a temporary power failure.

2. Description of the Related Art

Many individuals and companies utilize an uninterruptible power supply (“UPS”) or battery back-up for their personal computers, television sets, entertainment systems, and other modern day, and generally expensive or essential electronic devices. These UPS devices generally plug into or are otherwise directly connected to a power source such as a wall outlet and are structured to accept or receive AC power therefrom, convert the AC power to DC power, store the DC power in a battery, and re-convert the DC power from the battery back to AC power, which is then supplied or routed as an output from the UPS. This AC power is then utilized to power or run attached electronic devices.

Accordingly, in a typical UPS application, the user will install a UPS between the wall outlet or other power source and the power cable or power adapter of the electronic device. The UPS is generally structured to provide back up power to the electronic device and/or surge protection in the event of a power failure, power surge, etc. In particular, there are a plurality of common UPS designs and applications, such as, for example, on-line, double-conversion, line-interactive, offline/standby, hybrid topology or double conversion on demand, ferro-resonant, and rotary UPS systems, each of which comprise several unique advantages and disadvantages.

Such UPS devices are costly, bulky, heavy, and unnecessarily inefficient due to the way the power is received, converted, stored, and re-converted, as described above. The multiple AC-DC and DC-AC conversions create a significant amount of heat and waste a significant amount of power and energy.

Moreover, many electronic devices, including, but in no way limited to, cable and DSL modems, routers, switches, security systems, cameras, telephones, switch boards, etc., comprise a power adapter or transformer that is structured to receive AC power, for example, from a wall outlet, convert that AC power to DC, and provide the appropriate signal to the electronic device for operation. When these devices are connected to a typical UPS which comprises its own AC-DC and DC-AC converters, the amount of hardware, conversions, and loss of power becomes rather excessive. There is thus a need for an in-line uninterruptible power supply positioned and disposed between the power adapter and the base unit of the electronic device, rather than between the wall outlet and the power adapter, and which is structured to provide continuous power and/or surge protection to the electronic device even in the event of a power failure, brownout, blackout, power surge, microvoltage cuts or interruptions, etc.

### SUMMARY OF THE INVENTION

The present invention is generally directed to an in-line uninterruptible power supply for use with an electronic device, wherein the electronic device comprises a base unit and a power adapter. Specifically, the in-line uninterruptible power supply of the various embodiments of the present invention is cooperatively positioned and disposed between the power adapter and the base unit of the electronic device, and is further structured and configured to supply continuous power to the electronic device, even in the event of a temporary power failure. Specifically, the in-line UPS of the present invention uses the power adapter that comes with or is supplied by the electronic device that the user wishes to power. In at least one embodiment, the input and output of the in-line UPS device comprises DC power, eliminating extraneous AC-DC and DC-AC conversions, resulting in a significantly reduced cost, weight, and power loss, and further allowing the in-line UPS to power the electronic device for more than three times longer than traditional UPS devices with comparable or the same battery reserve power.

In particular, the various embodiments of the present invention comprise a housing, an input, an output, and a chargeable and/or rechargeable battery device, wherein the input and output are accessible from a position external to the housing. Moreover, the input of the in-line UPS of the present invention is structured to connect, either directly or indirectly (via a connecting adapter or tip), to a first end of the power adapter of the electronic device, the opposing second end of the power adapter being connected to a power source, such as a wall outlet. The output of the in-line UPS is structured to connect, either directly or indirectly (via a connecting adapter or tip), to the base unit of the electronic device, and in particular, to the jack or input designed for the power adapter, and supply continuous power thereto.

Accordingly, although most power sources and wall outlets supply AC power, the signal coming from or otherwise carried by the power adapter of the electronic device, in many applications, is DC power, as the power adapter, in many applications, comprises an AC-DC converter or transformer. Thus, in such an instance, the in-line UPS of the present invention need not comprise an input AC-DC converter. Oftentimes, however, the input signal or voltage coming from the power adapter may need to be raised or lowered so as to correspond with a predetermined battery input signal. Thus, in at least one embodiment the input of the in-line UPS is connected to an input signal converter, which is in turn connected to the internal rechargeable battery device. Therefore, the input signal (which in many instances is already in DC due to the power adapter hardware) may need to be “up-converted” or “down-converted” so as to correspond with a signal or voltage required to charge the battery device. The input signal converter in at least one embodiment is accomplished using an ultra high frequency range with small transformers, and thus maximizes efficiency with little to no power loss, relatively low heat, and minimal weight. In addition, less than 10% of the reserve power in the battery device is expanded as heat.

In addition, the in-line UPS device of the present invention may comprise an output signal converter connected to the rechargeable battery device and the in-line UPS output. In particular, the rechargeable battery device emits or discharges DC power which may need to be “up-converted” or “down-converter” so as to correspond with the input signal, or to otherwise properly power the electronic device for operation.

Certain electronic devices utilize AC power rather than DC power, and thus the power adapter associated with the particular electronic device may not convert the AC power from the power source to DC power, as explained above. In such an embodiment, the in-line UPS may direct the AC power at the input directly to the output and to the electronic device, at least partially bypassing the rechargeable battery device. In yet another embodiment, however, the in-line UPS may comprise an input AC-DC converter, and similarly, an output DC-AC converter. As the power adapter associated with the particular electronic device may generally convert the AC power source to a rather low voltage prior to reaching the input of the present invention, the input AC-DC converter, as well as the output DC-AC converter uses or otherwise comprises low voltage thereby minimizing the excessive power loss, heat generation, etc., associated with typical UPS units.

In addition, at least one embodiment of the in-line UPS of the present invention is structured and configured to accommodate or otherwise connect to a plurality of different electronic devices, each of which may comprise a unique connector, and require a unique signal or voltage to operate. Thus, the in-line UPS of at least one embodiment of the present invention is capable of accepting a range of inputs or input voltages, such as, for example, between 3 VDC and 48 VDC. The in-line UPS of at least one embodiment comprises appropriate hardware, circuitry, and devices, such as an input signal sensor to detect the input signal or voltage and automatically adjust the output signal to match. In yet another embodiment, however, the present invention comprises a manual signal or voltage selector accessible from a position external to the housing allowing the user to selectably control the output signal or voltage. It is also contemplated that the in-line UPS of the present invention is designed, customized, or configured to be operable with or otherwise accept an input from a specific predetermined signal or voltage.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of at least one embodiment of the in-line UPS disclosed in accordance with the present invention.

FIG. 1A is a schematic representation of an input connector adapter operatively disposed in accordance with at least one embodiment of the present invention.

FIG. 1B is a schematic representation of an output connector adapter operatively disposed in accordance with at least one embodiment of the present invention.

FIG. 2 is a rear elevation view of at least one embodiment of the in-line UPS disclosed in accordance with the present invention.

FIG. 2A is a front elevation view of the embodiment of the in-line UPS illustrated in FIG. 3.

FIG. 2B is a side elevation view of the embodiment of the in-line UPS illustrated in FIGS. 2 and 2A.

FIG. 3 is an illustrative and operative example of the in-line UPS disclosed in accordance with the present invention.

FIG. 4 is a schematic representation of at least one embodiment of the in-line UPS disclosed in accordance with the present invention.

FIG. 5 is a schematic representation of another embodiment of the in-line UPS of the present invention.

FIG. 6 is a schematic representation of yet another embodiment of the in-line UPS of the present invention.

FIG. 7 is a high level flow chart illustrating at least one embodiment of the method for providing an in-line UPS as disclosed herein.

Like reference numerals refer to like parts throughout the several views of the drawings.

### DETAILED DESCRIPTION OF THE PREFERRED EMBODIMENT

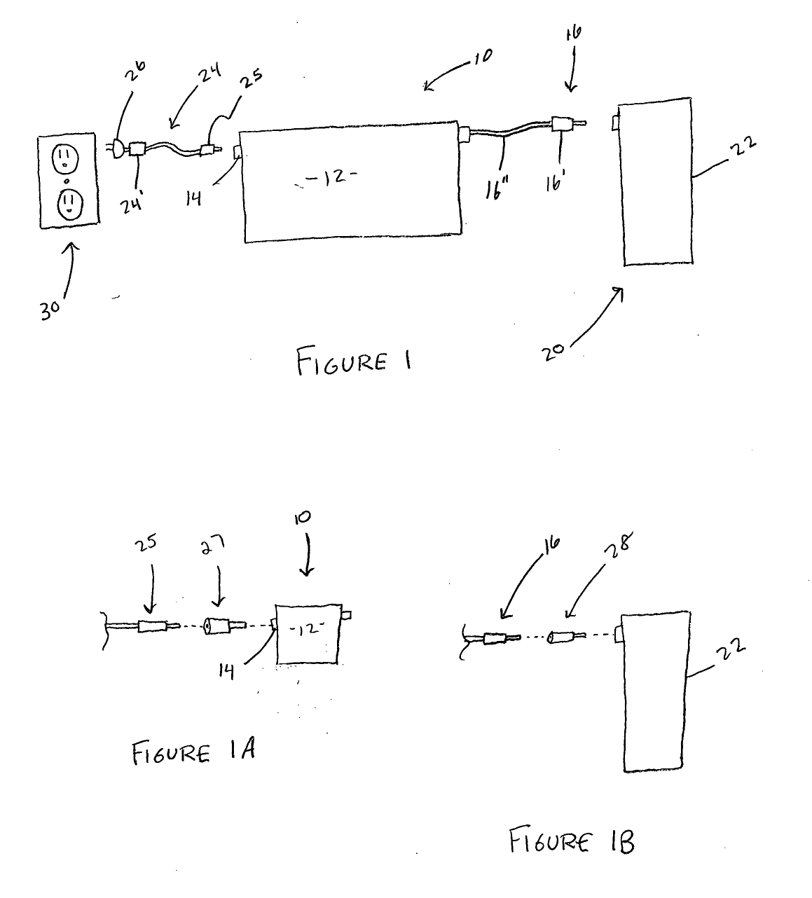

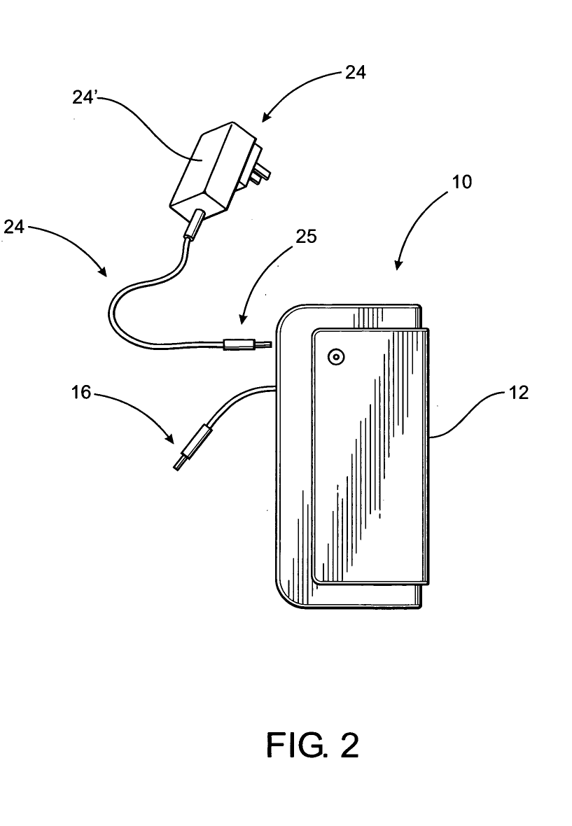

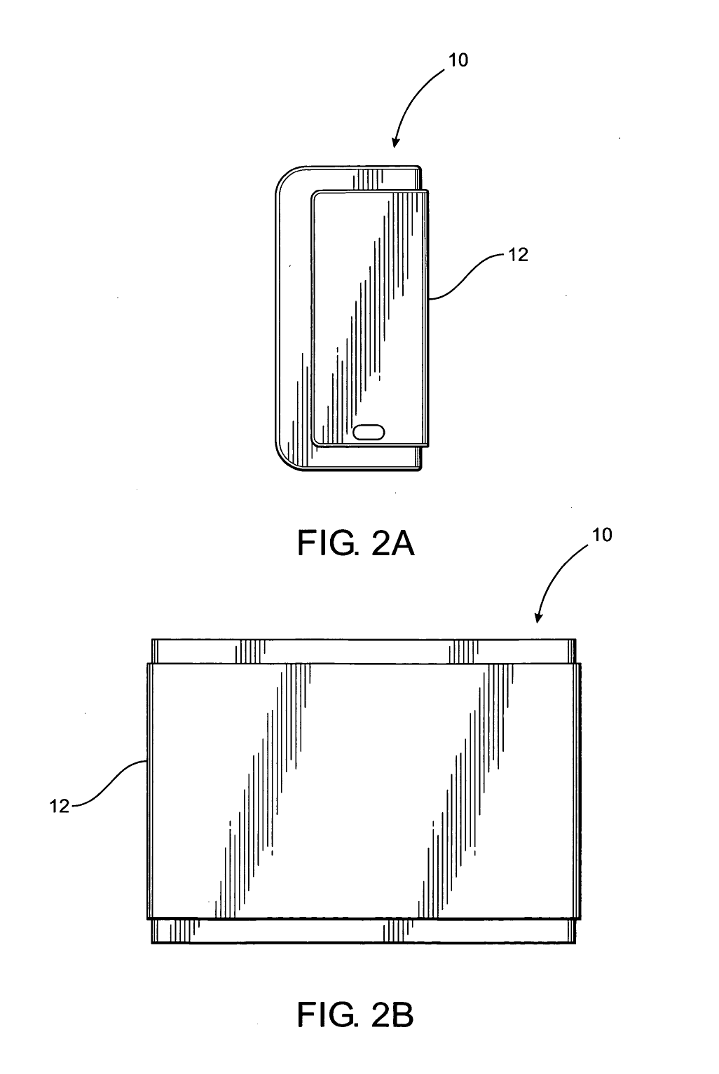

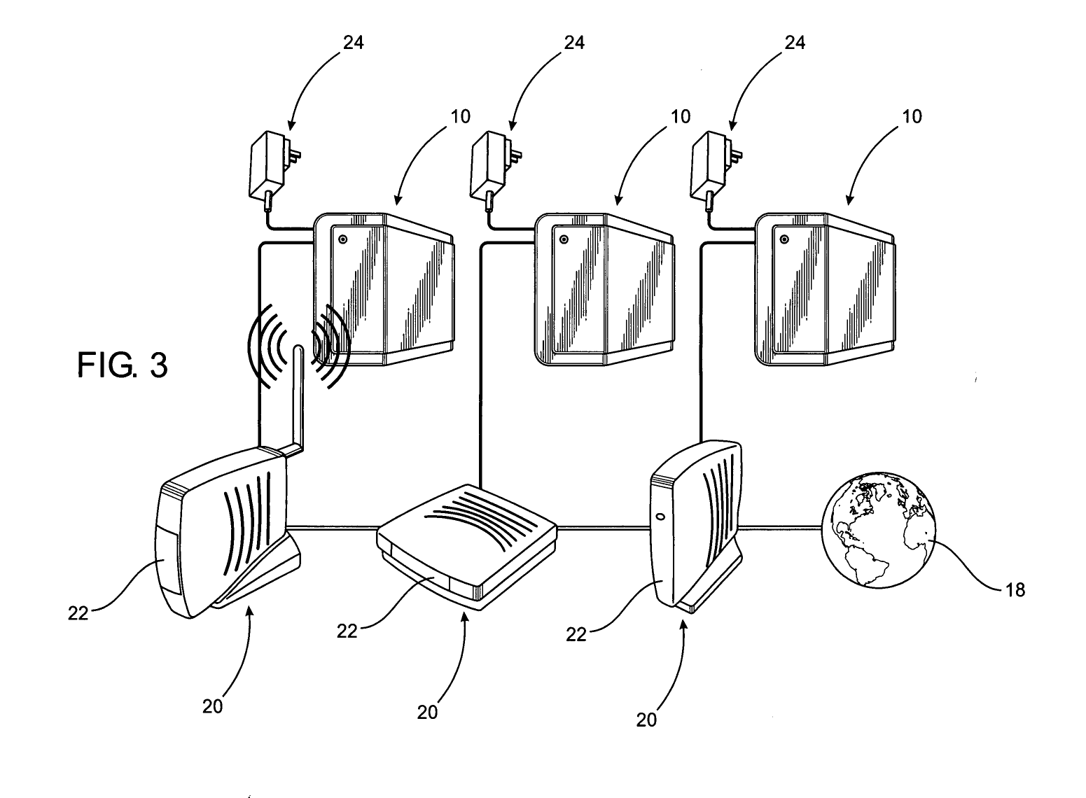

As shown in the accompanying figures, and with particular reference to FIGS. 1-3, the present invention is directed to an in-line uninterruptible power supply, generally referenced as 10, for use with an electronic device 20, wherein the electronic device 20 includes a base unit 22 and a power adapter 24. In particular, the in-line uninterruptible power supply 10 of the various embodiments of the present invention is cooperatively structured and configured to be disposed, positioned, and/or otherwise connected between the power adapter 24 and the base unit 22 of the electronic device 20.

For instance, many electronic devices 20, including, but certainly not limited to cable and DSL modems, routers, switches, desktop computers, laptop or mobile computers, printers, telephones, switch boards, security systems, cameras, etc., include a removable power adapter 24 or transformer that is structured to receive alternating current (“AC”) from a power source 30, such as a wall socket, convert the AC to direct current (“DC”), and provide the appropriate signal or voltage to the peripheral or base unit 22 for operation.

For instance, and referring now to an exemplary and illustrative embodiment and installation of the present invention shown in FIG. 3, the in-line uninterruptible power supply 10 of the various embodiments may be used with any of a plurality of electronic devices 20, such as a wireless router, switch, and/or high-speed internet modem, which are in turn connected to the Internet 18. Thus, in the event of a power failure, brownout, blackout, or other power malfunction, the in-line uninterruptible power supply 10 of the present invention will, for a period of time, continuously supply power to the device(s) 20, e.g., the Internet devices shown in FIG. 3, and maintain a connection with the Internet 18. This will, in turn, allow businesses to maintain a high level of worker productivity, which in many instances is dependent upon a continuous and reliable connection to the Internet, even during a temporary brownout, blackout, or power failure or malfunction. Of course the various embodiments of the present invention may be used in connection with a plurality of electronic devices 20, including, but certainly not limited to cable and DSL modems, routers, switches, desktop computers, laptop or mobile computers, printers, telephones, switch boards, security systems, cameras, solar panel and wind generators, charging control systems for solar panels and wind generators, etc.

Moreover, as mentioned above, the in-line uninterruptible power supply 10, or in-line UPS 10, of the various embodiments of the present invention is structured to be disposed and connected between the electronic device's 20 power adapter 24 and the base unit 20. Such a configuration eliminates the need for extraneous and high-voltage AC-DC and DC-AC conversions, eliminates unnecessary power loss, weight, and bulkiness, and allows the UPS to power the electronic device(s) 20 for a significant amount of time longer than traditional back-end UPS devices.

In particular, and referring now to FIG. 1, the various embodiments of the present invention comprise a casing or housing 12, at least one input 14, and at least one output 16. The input 14 is accessible from a position external to the housing 12 and is configured and structured to connect to or otherwise couple with a first end 25 of the power adapter 24 associated with the electronic device 20. In particular, the first end 25 of the power adapter 24 is typically connected directly to the base unit 22 of the electronic device 20 for applications not comprising the use of the in-line UPS 10 of the present invention. The first end 25, which comprises a power plug or connector, may be removed or disconnected from the base unit 22 and connected, either directly or indirectly (via an input connector adapter 27), to the input 14 of the in-line UPS device of the present invention.

In at least one embodiment, the input 14 comprises a female socket cooperatively structured to connect to the power connector located at the first end 25 of the power adapter 24. Further, in the event the connector located at the first end 25 of the power adapter 24 does not fit or couple with the input 14 directly, then at least one embodiment of the present invention further comprises at least one input connector adapter 27 cooperatively configured to connect or couple with both the first end 25 of the power adapter 24 and the input 14, as schematically illustrated in FIG. 1A.

Still referring to FIG. 1, the power adapter 24 comprises a second end 26 connected to a power source 30, such as, for instance a wall socket, electrical outlet, or electric plug. In most cases, the power source 30 supplies AC power to the power adapter 24. The power adapter 24 may then include a conversion device 24′ which may comprise an AC-DC converter, AC-AC converter, or other proper circuitry, device(s), or converters appropriate for the corresponding base unit 22 to operate. Accordingly, depending upon the particular device 20, the signal, such as the voltage, power, and/or current at the input 14 may vary and be either AC or DC.

Furthermore, as illustrated in FIG. 1, the various embodiments of the in-line UPS 10 of the present invention comprise an output 16 accessible from a position external to the housing 12 and structured and configured to be disposed in a direct or indirect connecting relation to the base unit 22 of the electronic device 20. As illustrated in FIG. 1, the output 16 of at least one embodiment may comprise a power connector 16′ disposed at the end of a cable 16″, however, other configurations structured to facilitate the operation of the present invention in the intended manner are contemplated. In particular, the output 16 and/or power connector 16′ thereof is, in at least one embodiment, coupled to the input from which the power adapter 24 was removed or disconnected, as described above. Furthermore, at least one embodiment comprises an output connector adapter 28 cooperatively configured to connect or couple with both the output 16 or power connector 16′ thereof and an input of the base unit 22, as schematically illustrated in FIG. 1B.

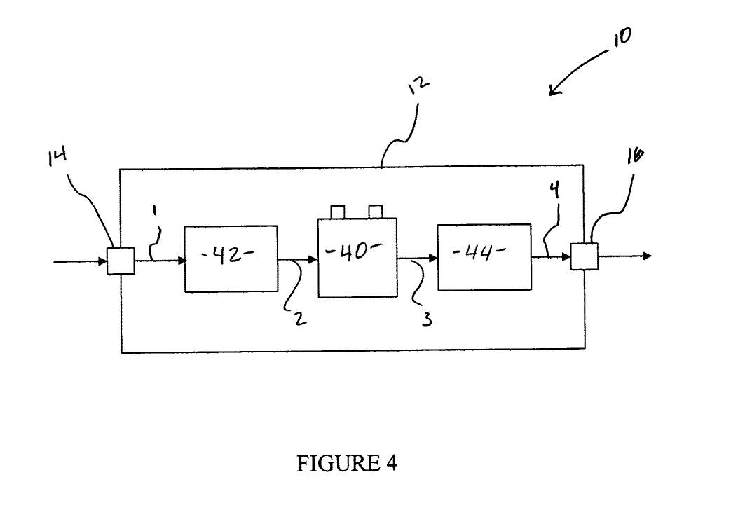

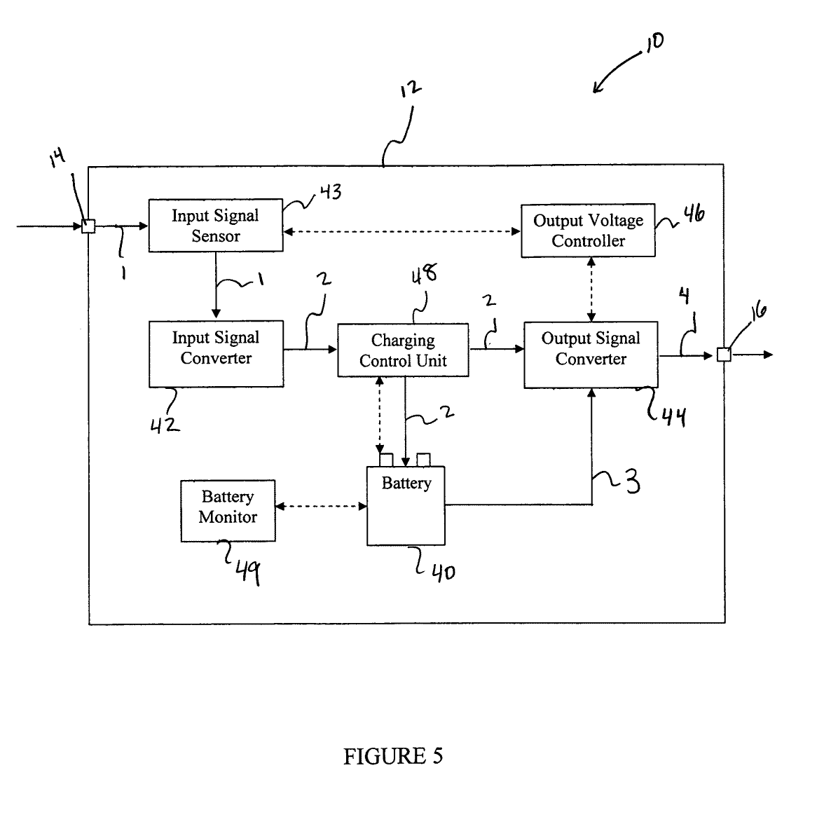

Referring now to FIG. 4, the various embodiments of the present invention comprise a rechargeable battery device 40 disposed within the housing 12 and in a direct or indirect communicative relation with the input 14 and output 16. The rechargeable battery device 40 of the various embodiments comprises virtually any type of battery structured to receive, store, and output a charge or power, including, but certainly not limited to an internal lead acid battery. Moreover, the rechargeable battery device 40 is structured to receive a battery input signal or voltage, as generally and schematically referenced at 2, which in turn is structured to charge the battery device 40. Similarly, the battery device 40 is structured to emit or discharge a battery output signal or voltage, generally and schematically referenced at 3.

Further, because the voltage level or battery input signal 2 required to charge the rechargeable battery device 40 may be different from the voltage level, current or signal provided by the power adapter 24 of the electronic device 20, such as a UPS input signal or first source, generally and schematically referenced at 1, at least one embodiment of the present invention further comprises an input signal converter 42. The input signal converter 42 is disposed in a communicative or connected relation with the input 14 and the rechargeable battery device 40, and is cooperatively structured to convert the first source or UPS input signal 1 to the appropriate battery input signal or voltage 2 operative to charge the battery device 40. In particular, because the input signal 1 of at least one embodiment comprises DC power, and because the rechargeable battery device 40 of at least one embodiment requires DC power to charge, the input signal converter 42 of such an embodiment comprises a DC to DC voltage converter structured to raise and/or lower the voltage as needed.

Moreover, at least one embodiment of the in-line UPS 10 is configured and structured to connect with or adapt to a plurality of different electronic devices 20, and thus, the input 14 is structured to accept a range of input voltages. For exemplary purposes only, the voltage supplied by the power adapter 24 of the particular electronic device 20 may be anywhere within a wide range of input voltages, such as, 3 VDC to 48 VDC, whereas the battery device 40 may require a particular predefined input signal or voltage, such as, a 6 VDV input. Thus, if, for example, the UPS input signal 1 is equal to 3 VDC, and the battery device 40 requires a 6 VDC input, then the input signal converter 42 of at least one embodiment is structured to “up-convert” the UPS input signal or voltage 1 to the required battery input signal or voltage 2. Also, if, for example, the UPS input signal 1 of one application of the present invention is equal to 48 VDC, and the battery device 40 again requires a 6 VDC input, then the input signal converter 42 is structured to “down-convert” the UPS input signal 1 to the required battery input signal 2. Of course, the above voltages and voltage ranges are merely presented for exemplary purposes only, and the present invention is in no way limited to such.

In addition, at least one embodiment of the present invention comprises an input signal or voltage sensor 43 disposed in a communicative and signal-reading relation with the input 14 and/or the input signal converter 42. In particular, the input signal sensor 43 comprises appropriate circuitry and/or microprocessor(s) structured to detect and measure the signal, such as the voltage and/or current levels, at the input 14. Thus, at least one embodiment of the present invention is structured to receive a range of input signals or input voltages, detect the input signal via the input signal sensor 43, and convert the input signal or voltage as necessary.

Furthermore, and still referring to FIG. 4, at least one embodiment of the present invention comprises an output signal converter 44 disposed in a communicative relation with the rechargeable battery device 40 and the output 16. In particular, the output signal converter 44 comprises appropriate circuitry, logic, and devices structured to convert a battery output signal or voltage 3 to, for example, a UPS output signal 4 located at the output 16. In particular, because the base unit 22 of the electronic device 20 is structured to accepts the signal coming from its own power adapter 24 (which is connected to the UPS input 14), in at least one embodiment, the present invention comprises appropriate circuitry, logic or devices to ensure that the UPS input signal 1 is equivalent or substantially equivalent to the UPS output signal 4. Furthermore, because the battery output signal 3 of at least one embodiment comprises DC power, and because the UPS input signal 1 (and thus the UPS output signal 4) of at least one embodiment comprises DC power, the output signal converter 44 of such an embodiment comprises a DC to DC voltage converter structured to raise or lower the voltage as needed. Accordingly, the battery output signal 3 may, in some instances, need to be “up-converted” or “down-converted” so as to appropriately raise or lower the voltage, respectively.

For instance, in at least one embodiment, the present invention comprises an output signal controller 46 disposed in a communicative relation with, and being structure to at least partially control, the output signal converter 44. The output signal controller 46 is further disposed in a communicative relation with the input signal sensor 43 in that the output signal converter 46 is structured to receive information or data relating to the input signal 1, such as its voltage, current, etc., and control or otherwise communicate this information to the output signal converter 44. The output signal converter 44 can then appropriately convert the battery output signal 3 if necessary so as to be equivalent or substantially equivalent to the input signal 1.

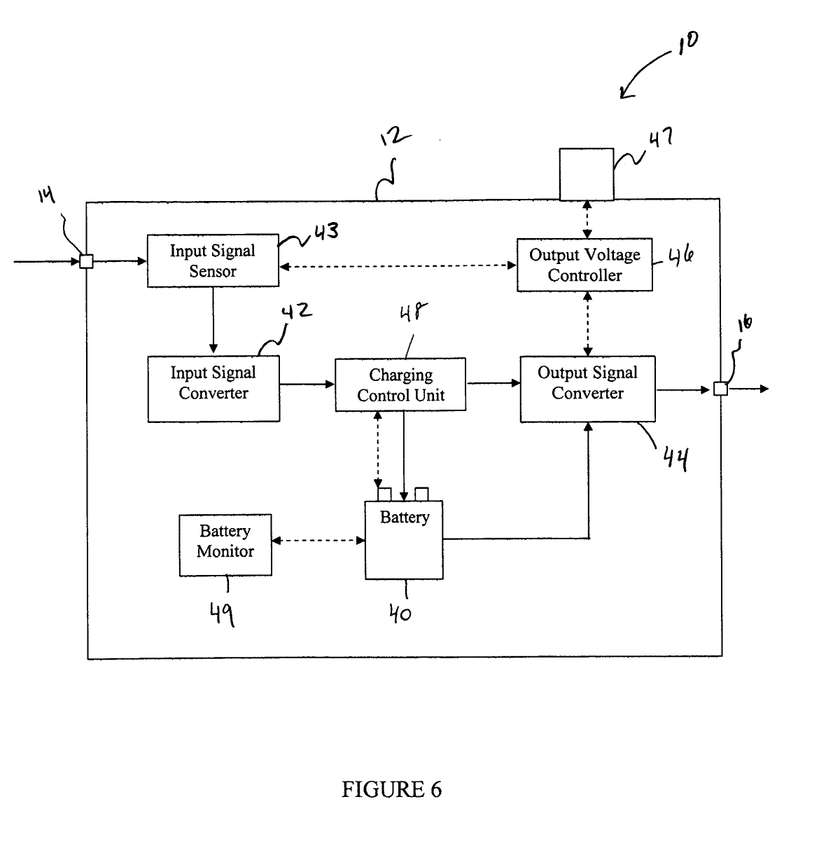

In yet another embodiment, and as shown in FIG. 6, the output signal controller 46 is disposed in a communicative relation with a signal or voltage selector 47. In particular, the voltage selector 47 is at least partially externally accessible such that a user or other individual may manually and/or selectively adjust the output voltage or output signal 4 for the in-line UPS 10 of the present invention. Thus, rather than automatically detecting the input signal and communicating the same to the output signal converter 44, as discussed above, at least one embodiment is structured to allow a user to manually and selectively adjust the output signal 4 or voltage. Accordingly, the voltage or signal selector 47 may comprise a sliding, rotating, or other adjustable or selectable switch, notch, potentiometer, etc.

Furthermore, as identified above, the input signal 1 from the power adapter 24 may comprise AC or DC. In at least one embodiment, if the input signal sensor 43 or other circuitry detects that the input is AC, the AC source will bypass the various components described above, and will be directed to the output 16 and into the base unit 22 of the electronic device 20. It is also contemplated however, that in at least one embodiment, an input AC-DC converter and output DC-AC converter is included in the in-line UPS 10 of the present invention so as to allow the rechargeable battery device 40 to charge and thus the in-line UPS 10 of at least one embodiment may be structured to accommodate and be operable with devices that operate by or otherwise receive AC signal(s). In particular, the AC-DC and DC-AC converters may but need not comprise a set of diodes or other hardware structured to appropriately convert the signal. Additionally, the power adapter of the electronic device 20 generally converts the AC input signal to a low voltage, and as such, the AC-DC and/or DC-AC converter(s) of at least one embodiment utilizes or otherwise operates at a low voltage thereby minimizing power loss and heat generation.

In addition, the present invention may also include a charging control unit 48 disposed in a communicative relation with the rechargeable battery device 40. In particular, the charging control unit 48 comprises appropriate circuitry and logic to manage the charging of and/or regulate power to the rechargeable battery device 40. For instance, the charging control unit 48 of at least one embodiment is structured to detect the battery level of the battery device 40, and if it is below a certain level or otherwise not charged to its maximum potential, the charging unit 48 is structured to direct the input signal 1 to the battery 40 and/or to the input signal converter 42. If the charging control unit 48 detects that the battery device 40 is fully charged, then in at least one embodiment, the charging control unit 48 is structured to direct the input signal 1 directly to the output 16. In the event of a power failure, brownout, blackout, microvoltage cut or interruption, etc., the in-line UPS 10 is structured to continuously supply power from the battery device 40 as described above.

In addition, and for exemplary purposes only, certain power adapters 24 configured for use with an electronic device 20 are designed or implemented with excess capacity structured to handle the maximum load anticipated by the attached device 20. In many cases, this excess capacity is designed as a safety feature from the original manufacturer. For instance, many peripherals and devices 20 draw or consume more power at start-up or when the device 20 is initially powered on than when the device has been running for some time and has reached a steady state. This extraneous or excess capacity can be used, for instance by the charging control unit 48 of at least one embodiment of the present invention to charge the rechargeable battery device 40 that may later provide power to the device 20 upon the occurrence of a brownout, blackout, or other power failure or malfunction. For instance, the input signal, whether it be AC or DC, may be split, divided, allocated or otherwise utilized in a manner such that at least a portion of the excess power capacity is routed so as to charge the battery, while the remaining power is concurrently used or routed to operate the electronic device. Of course the input signal or portions of the input signal may, depending upon the particular application, need to pass though an input signal converter, for instance, so as to “up-convert,” “down-convert,” or convert to/from AC-DC as necessary and as discussed in detail above.

Further, at least one embodiment of the present invention comprises a battery monitor device 49 disposed in a communicative and monitoring relation with the rechargeable battery device 40. In particular, the battery monitor device 49 comprises appropriate circuitry, logic, and devices structured to monitor the battery level of the rechargeable battery device 40 and emit one or more signals, for instance audible and visual warnings, at a predetermined or preprogrammed moment, such as ten (10) minutes prior to the rechargeable battery device 40 being completely depleted and power being disconnected to the electronic device 20.

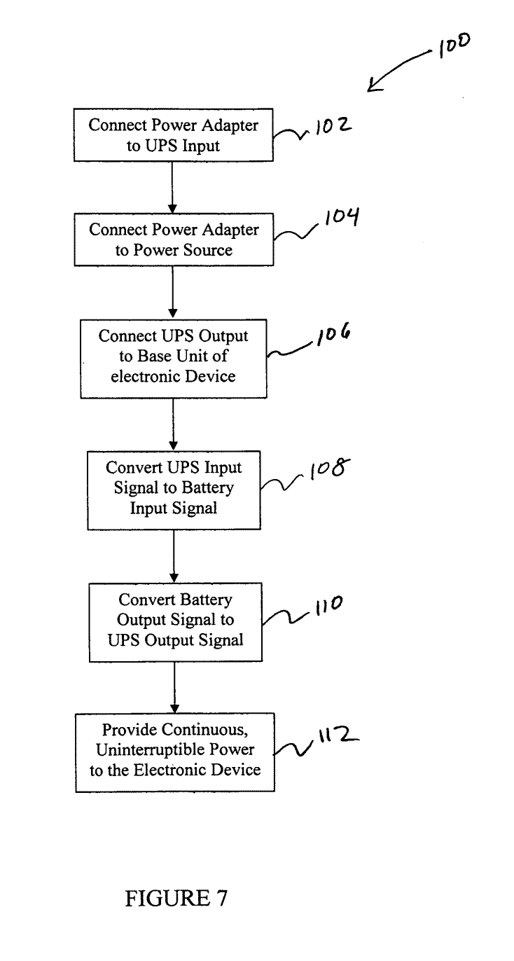

Additionally and as generally represented in the high level flow chart of FIG. 7, the present invention further comprises a method for providing an in-line uninterruptible power supply 100 to the electronic device. In particular, the method 100 of at least one embodiment comprises providing a UPS input for connecting the first end of the power adapter thereto 102, connecting the second end of the power adapter to the power source such as a wall outlet 104, and providing a UPS output for connecting to the base unit of the electronic device 106. Of course, as described above, the first end of the power adapter may connect either directly to the UPS input, or indirectly via the use of an input connector adapter. Similarly, the UPS output may connect directly to the base unit or indirectly via an output connector adapter.

The method 100 further comprises converting a UPS input signal from the power adapter to a predetermined battery input signal 108, for instance, via a DC to DC input signal converter. Specifically, the battery input signal is structured to charge the rechargeable battery device of the in-line UPS and in at least one embodiment comprises a predetermined DC power or voltage. As the UPS input signal of at least one embodiment is also DC power (which is carried by the power adapter of the electronic device), the UPS input signal may need to be “up-converted” or “down-converted” as necessary to correspond with the predetermined battery input signal or voltage.

In addition, the method 100 of at least one embodiment comprises converting a battery output signal to a UPS output signal 110, for instance, via a DC to DC output signal converter. In particular, the battery output signal of at least one embodiment comprises DC power. In addition, the base unit of the electronic device of at least one embodiment is structured to run or operate via DC power. Thus, the battery output signal may, in some instances, need to be “up-converted” or “down-converted” to correspond to the appropriate signal or voltage level required to operate the base device.

Finally, the method 100 of the various embodiments of the present invention comprises providing continuous, uninterruptible power to the electronic device via the UPS output 110, even in the event of a power failure from the power source. Specifically, the method 100 and/or in-line UPS 10 of the various embodiments of the present invention may be configured in any of a number of manners so as to provide continuous power to the electronic device. In particular, there are a plurality of common UPS configurations, for example, on-line, double-conversion, line-interactive, off-line, hybrid, etc., some of which continuously supply power from the battery even during proper power source functionality, and others which may be structured to switch to the battery device only upon the occurrence of a power failure or malfunction. Accordingly, the method 100 and in-line UPS 10 of the present invention may operate in any of these manners cooperatively structured to implement the operative features of the present invention in the intended manner, as described in detail herein.

Since many modifications, variations and changes in detail can be made-to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. An in-line uninterruptible power supply for an electronic device, the electronic device comprising at least one base unit and a power adapter, said in-line uninterruptible power supply comprising:
a housing,
an input disposed in a connected relation with a first end of the power adapter of the electronic device, wherein a second end of the power adapter of the electronic device is disposed in a connected relation to a power source,
an output disposed in a connected relation with the at least one base unit of the electronic device,
a rechargeable battery device disposed within said housing and in a communicative relation with said input and said output, and
at least one input signal converter disposed in a communicative relation with said rechargeable battery device, said at least one input signal converter being structured to convert a UPS input signal to a corresponding battery input signal, said battery input signal being structured to at least partially charge said rechargeable battery device.

2. The in-line uninterruptible power supply as recited in claim 1 wherein said UPS input signal comprises DC power.

3. The in-line uninterruptible power supply as recited in claim 2 wherein said input signal converter comprises a DC-DC voltage converter.

4. The in-line uninterruptible power supply as recited in claim 1 wherein said input is structured to accept a range of input voltages.

5. The in-line uninterruptible power supply as recited in claim 4 further comprising an input signal sensor disposed in a communicative relation with said input for detecting and measuring said UPS input signal at said input.

6. The in-line uninterruptible power supply as recited in claim 5 further comprising an output signal converter disposed in a communicative relation with said rechargeable battery device and said output; said output signal converter being structured to convert a battery output signal to a UPS output signal.

7. The in-line uninterruptible power supply as recited in claim 6 wherein said battery output signal and said UPS output signal comprise DC power.

8. The in-line uninterruptible power supply as recited in claim 7 where said output signal converter comprises a DC-DC voltage converter.

9. The in-line uninterruptible power supply as recited in claim 6 further comprising an output signal controller disposed in a communicative relation with, and being structured to at least partially control, said output signal converter.

10. The in-line uninterruptible power supply as recited in claim 9 wherein said output signal controller is disposed in a communicative relation with said input signal sensor.

11. The in-line uninterruptible power supply as recited in claim 9 wherein said output signal controller is disposed in a communicative relation with an externally disposed voltage selector.

12. The in-line uninterruptible power supply as recited in claim 9 wherein said UPS input signal is substantially equivalent to said UPS output signal.

13. The in-line uninterruptible power supply as recited in claim 1 wherein an excess power capacity of the power adapter of the electronic device is used to at least partially charge the rechargeable battery device.

14. The in-line uninterruptible power supply as recited in claim 1 further comprising a charging control unit disposed in a communicative relation with said rechargeable battery device and structured to regulate power to said rechargeable battery device.

15. The in-line uninterruptible power supply as recited in claim 1 further comprising a battery monitor disposed in a communicative relation with said rechargeable battery device; said battery monitor comprising at least one audible warning device for communicating a battery status.

16. An in-line uninterruptible power supply for an electronic device, the electronic device comprising at least one base unit and a removable power adapter, said in-line uninterruptible power supply comprising:
a housing,
an input accessible from a position external to said housing, said input being connected to a first end of the removable power adapter of the electronic device, wherein a second end of the removable power adapter of the electronic device is connected to a power source, said input being structured to accept at least one DC UPS input signal,
an output accessible from a position external to said housing, said output being connected to the at least one base unit of the electronic device, said output being structured to carry at least one DC UPS output signal,
a rechargeable battery device disposed within said housing and in a communicative relation with said input and said output, said rechargeable battery device comprising a battery input signal and a battery output signal,
a DC to DC input signal converter disposed in a communicative relation with said rechargeable battery device, said DC to DC input signal converter being structured to convert said DC UPS input signal to said battery input signal, said battery input signal being structured to at least partially charge said rechargeable battery device, and
a DC to DC output signal converter disposed in a communicative relation with said rechargeable battery device and said output, said DC to DC output signal converter being structured to convert said battery output signal to said DC UPS output signal.

17. The in-line uninterruptible power supply as recited in claim 13 wherein said input is structured to accept a predetermined range of DC UPS input signals.

18. The in-line uninterruptible power supply as recited in claim 12 wherein said DC UPS input signal is substantially equivalent to said DC UPS output signal.

19. A method for providing an in-line uninterruptible power supply to an electronic device, the electronic device comprising at least one base unit and a removable power adapter, the method comprising:
connecting a first end of the removable power adapter to a UPS input, connecting a second end of the removable power adapter to a power source, and connecting a UPS output to the base unit of the electronic device,
converting a UPS input signal from the power adapter to a predetermined battery input signal via a DC to DC input signal converter, the battery input signal being structured to at least partially charge a rechargeable battery device, the rechargeable battery device being disposed in a communicative relation with the DC to DC input signal converter,
converting a battery output signal to a UPS output signal via a DC to DC output signal converter, the rechargeable battery device being disposed in a communicative relation with the DC to DC output signal converter, the UPS output signal being at least substantially equivalent to the UPS input signal, and
providing continuous, uninterruptible power to the electronic device via the UPS output even in the event of a power failure from the power source.

20. The method as recited in claim 19 further comprising automatically detecting the UPS input signal via an input signal sensor disposed in a communicative relation with the UPS input.

21. The method as recited in claim 20 further comprising automatically regulating the DC to DC output signal converter based at least partially upon the detected UPS input signal.

22. The method as recited in claim 19 further comprising selectively and manually adjusting the UPS output signal via an at least partially externally accessible voltage selector.
